(19) United States
(12) Patent Application Publication
(10) Pub. No.: US 2014/0129474 A1
(43) Pub. Date: May 8, 2014

(54) SYSTEM AND METHOD OF AUTOMATICALLY SETTING SORTING BOXES FOR AUTOMATIC MAIL SORTING

(71) Applicant: Electronics and Telecommunications Research Institute, Daejeon (KR)

(72) Inventor: Hong Kyu PARK, Daejeon (KR)

(21) Appl. No.: 13/918,504

(22) Filed: Jun. 14, 2013

(30) Foreign Application Priority Data
Nov. 6, 2012 (KR) 10-2012-0124765

(51) Int. Cl. G06Q 10/08

(52) U.S. Cl. CPC G06Q 10/083
USPC 705/330

(57) ABSTRACT

Provided are a system and a method for automatically setting sorting boxes for automatic mail sorting, and as the position of a sorting box of mail is informed by automatically changing sorting band information depending on a change of a postal area and using address information and barcode information of mail and the system is designed so as for a mailman not to perform PDA work for registered mail, so that the mailman needs not modifying sorting box information with the change of the postal area all the time and the mailman can easily find the sorting box of the corresponding mail although the position of the sorting box is changed by informing the mailman of the position of the sorting box of the corresponding mail, and the corresponding sorting box can be automatically known even though the postal area is changed or a new postal area is assigned.

### CROSS-REFERENCE TO RELATED APPLICATIONS

This application claims priority to and the benefit of Korean Patent Application No. 30-2012-0124765 filed in the Korean Intellectual Property Office on Nov. 5, 2012, the entire contents of which are incorporated herein by reference.

### TECHNICAL FIELD

The present invention relates to a technical field relating to mail classification based on mail information for delivering mail. More particularly, the present invention relates to a system and a method which are applied to mail sorting boxes as a technique relating to separating and classifying the mail for performing optimal mail delivery by acquiring the mail information.

### BACKGROUND ART

In a distributing post office which delivers mail to a customer, mail sequence sorting work in which the mail is sorted according to a mail delivery path order is performed so that a mailman delivers the mail. General mail is primarily classified by a sequence sorting device (a machine which classifies the entire general mail of the distributing post office into the mail corresponding to each mailman or each collection and delivery team, and the mailman inputs the primarily classified general mail into a sorting box in accordance with the corresponding path. In registered mail, mail allocated to the mailman is primarily classified in a special system, and the mailman inputs the primarily classified registered mail into the corresponding sorting box in accordance with an allocated path and scans the registered mail allocated before delivering by using a PDA (in order to inform the system of information on the registered mail allocated to the mailman).

### SUMMARY OF THE INVENTION

A postal area which is a postal district which a mailman takes charge of is frequently changed in a distributing post office depending on an increase of population, an increase of a building, a change of an administrative district, and a workload. The mailman needs to change a delivery district address corresponding to a sorting box when a postal area of the mailman is changed, and as a result, efficiency of a business deteriorates in a sequence sorting work due to positional variation of a sorting box to sort mail in the related art, and it is difficult to estimate an amount to be input into the sorting box, and as a result, the sorting box cannot be efficiently used and a mailman who is assigned with a new postal area needs to modify the position of the sorting box and the information of the sorting box depending on a delivery path, which serve as an additional business element. Sorting work is difficult due to the position and information of a new sorting box.

The present invention has been made in an effort to provide a system and a method that improve efficiency of sorting work by automatically changing sorting box address information to be appropriate to a mail input amount in accordance with sorting box information used by a mailman by using statistics of corresponding population density and mail in a postal area, and recognizing address or barcode information by passing the mail through a scanning device to display the address or barcode information in the corresponding sorting box into which the mail is input so as for a worker to recognize the address or barcode information.

An exemplary embodiment of the present invention provides a system of automatically setting sorting boxes for automatic mail sorting, including: a sorting unit determining information to be displayed in each sorting box input with mail based on a mail information DB which is stored in advance; and a display unit receiving the information to be displayed in each sorting box and displaying the received information.

The mail information DB of the sorting unit may include a postal area DB storing, in advance, address information in a postal area for each mailman, and the sorting unit may determine the information to be displayed in each sorting box in accordance with the postal area information.

The mail information DB of the sorting unit may further include a registered mail statistics DB storing, in advance, amount statistics of existing registered mail, and the sorting unit may determine the information to be displayed in each sorting box by further considering the amount statistics.

The mail information DB of the sorting unit may further include a census statistics DB storing, in advance, population density statistics, and the sorting unit may determine the information to be displayed in each sorting box by further considering the population density statistics.

The information to be displayed in each sorting box of the sorting unit may be address information of each sorting box, and the sorting unit may update a sorting box DB storing, in advance, the address information of the existing sorting box by using the address information of each sorting box.

The system may further include an information acquiring unit scanning mail input from the outside to acquire mail information, and the mail information of the information acquiring unit may be character recognition information of the mail or barcode information of the registered mail, and the information acquiring unit may acquire the address information from the character recognition information or the barcode information.

The mail information DB of the sorting unit may include a sorting box DB storing, in advance, the address information of each sorting box, and the sorting unit may further determine the information to be displayed in each sorting box by matching the address information of each sorting box and the address information acquired by the information acquiring unit.

The information to be displayed in each sorting box may be the address information of each sorting box and an input display indicating a sorting box into which the mail is input.

The information acquiring unit may include a scanner acquiring information of mail; a mail supplying device automatically supplying a large amount of mail to the scanner; and a mail conveying device conveying the mail in which acquiring the information of the mail of the scanner is completed.

Another exemplary embodiment of the present invention provides a method of automatically setting sorting boxes for automatic mail sorting, including: determining information to be displayed in each sorting box input with mail based on a mail information DB which is stored in advance; and receiving the information to be displayed in each sorting box and displaying the received information.

The mail information DB of the determining may include a postal area DB storing, in advance, address information in a postal area for each mailman, and in a determination method of the determining, the information to be displayed in each sorting box may be determined in accordance with the address information in a postal area.

The mail information DB of the determining may include a registered mail statistics DB storing, in advance, mail amount statistics of existing registered mail, and in the determination method of the determining, the information to be displayed in each sorting box may be determined in accordance with the mail amount statistics.

The mail information DB of the determining may include a census statistics DB storing, in advance, population density statistics and in the determination method of the determining, the information to be displayed in each sorting box may be determined in accordance with the population density.

The information to be displayed in each sorting box of the determining may be address information of each sorting box, and the determining may further include updating a sorting box DB storing, in advance, the address information of the existing sorting box by using the address information of each sorting box.

The method may further include, before the determining, scanning mail to acquire mail information, and the mail information of the acquiring is character recognition information of the mail or barcode information of the registered mail, and the address information is acquired from the character recognition information or the barcode information.

The mail information DB of the determining may include a sorting box DB storing, in advance, the address information of each sorting box, and in the determining, the information to be displayed in each sorting box may be determined by matching the address information of each sorting box and the address information acquired by the information acquiring unit.

The information to be displayed in each sorting box may be an input display indicating a sorting box into which the mail is input.

According to exemplary embodiments of the present invention, the position of a sorting box of mail is automatically informed by automatically changing sorting box information depending on a change of a postal area and using address information and barcode information of mail and the system is designed so as for a mailman not to perform PDA work for recorded mail, so that the mailman needs not modifying sorting box index information with the change of the postal area all the time and the mailman can easily find the sorting box of the corresponding mail even though the position of the sorting box is changed by informing the mailman of the position of the sorting box of the mail, and the corresponding sorting box can be automatically known even though the postal area is changed or a new postal area is assigned, to thereby improve efficiency of mail sequence sorting work.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of a system of automatically setting sorting boxes for automatic mail sorting according to an exemplary embodiment of the present invention.

FIG. 2 is a structural diagram of an information acquiring unit 10 of the system of automatically setting sorting boxes for automatic mail sorting according to the exemplary embodiment of the present invention.

FIG. 3 is a block diagram of a sorting unit 20 of the system of automatically setting sorting boxes for automatic mail sorting according to the exemplary embodiment of the present invention.

FIG. 4 is a structural diagram of a display unit 30 of the system of automatically setting sorting boxes for automatic mail sorting according to the exemplary embodiment of the present invention.

FIG. 5 is a flowchart of a method of automatically setting sorting boxes for automatic mail sorting according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

In the following description and the accompanying drawings, like reference numerals designate substantially like elements, and the duplicated description will be omitted. In describing the present invention, well-known related functions or configurations will not be described in detail since the detailed description for the well-known related functions or configurations may unnecessarily obscure the understanding of the present invention.

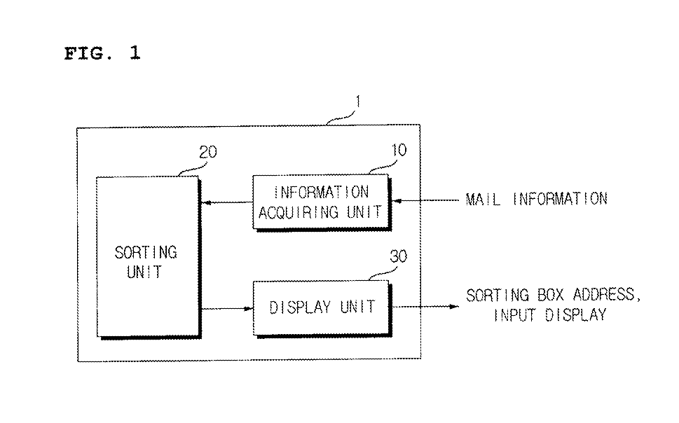

The present invention relates to a system and a method of automatically setting sorting boxes for automatic mail sorting and will be described below with reference to FIGS. 1 to 5. However, those skilled in the art will easily understand that the detailed description of this specification with reference to the drawings is just exemplified because the present invention is expanded beyond the limited exemplary embodiments.

FIG. 1 is a block diagram of a system of automatically setting sorting boxes for automatic mail sorting according to an exemplary embodiment of the present invention.

A system 1 of automatically setting sorting boxes of FIG. 1 includes an information acquiring unit 10, a sorting unit 20, and a display unit 30.

The information acquiring unit 10 scans mail to acquire information of the mail. The information of the mail of the information acquiring unit 10 may be character recognition information of the mail or barcode information of registered mail. A scanning method of the information acquiring unit 10 may be character recognition through image photographing, information recognition using an RFID tag, barcode recognition through a barcode scanner, or the like, and is not limited to the listed methods.

The information acquiring unit 10 finally acquires address information from the character recognition information of the mail or finally acquires address information from the barcode information based on a registered mail DB (not illustrated).

Particularly, in the case of the character recognition, an apparatus capable of recognizing a character may include an optical character reader (OCR) capable of recognize both printed characters and handwritten characters, an optical mark reader (OMR) capable of recognize specific characters, and a magnetic ink character reader (MICR) and an image recognition apparatus as a next-generation recognition apparatus may become an exemplary embodiment of the present invention.

Since reliability of a reading result is important in the recognition by the OCR, a predetermined degree of limit is set on an input character in order to secure recognition information. A standard character type of an OCR printed character includes OCR-A and OCR-B, and initially, the OCR-A type is used, but presently, the OCR-B type is used because it is not easy for a person to read the OCR-A type. Since it is difficult to strictly define the shape of a handwritten character by using a mechanical size unlike the printed character, there are several problems in recognizing the handwritten character. As a general index, whether to clearly distinguish a characteristic line configuring the character, easiness to write, whether to have a natural character shape, and the like are primarily examined. The size and the shape of a character writing column are simultaneously limited in order to stabilize the size and the shape of the handwritten character. A character recognition method in the related art may be generally classified into pattern matching and structure analysis. The former is primarily used to recognize the printed character and the latter is primarily used to recognize the handwritten character. An intermediate character recognition method of both methods includes feature matching and stroke analysis which are used dividually in accordance with respective uses or purposes.

The sorting unit 20 determines information to be displayed in each sorting box into which the mail is input based on a predetermined stored mail information DB and transmits the information to be displayed in each sorting box to the display unit 30. The information to be displayed in each sorting box includes address information of the sorting box and mail input display.

The mail information DB as a DB storing information for processing the mail or verifying address information of the mail includes a registered mail statistics DB, a census statistics DB, a postal area DB, and a sorting box DB. The DB will be described below.

The display unit 30 receives the information to be displayed in each sorting box from the sorting unit 20 and displays the received information in each sorting box.

The display unit 30 allows the address information and the mail input display to be displayed in each sorting box. The mail input display means displaying the mail so as to be input into a corresponding sorting box. In a character display method of the display unit 30, a character having a simple character shape such as English, numerals, or Korean is a little different from a character having a complicated character shape such as Chinese characters in terms of generation method, but the character display method is basically divided into a dot method, a stroke method, and a monoscope method.

A device type of the display unit 30 may include one of a CRT display device, a storage type display device, electroluminescence (EL), a liquid crystal display (LCD), a light emitting diode (LED), an organic light emitting diode (OLED), and a plasma display panel (PDP).

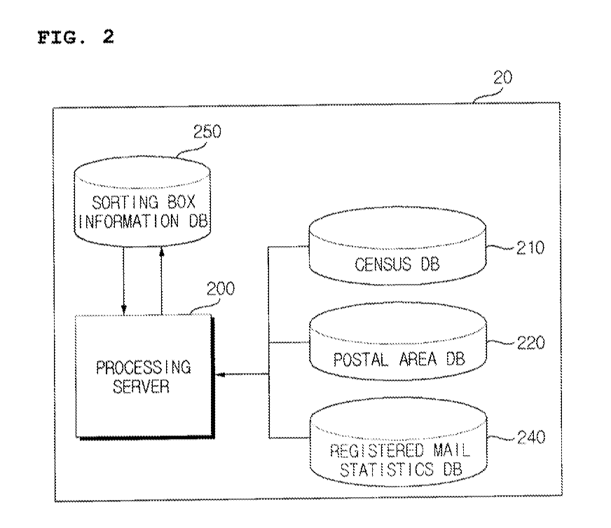

FIG. 2 is a structural diagram of the information acquiring unit 10 according to the exemplary embodiment of the present invention.

The information acquiring unit 10 illustrated in FIG. 2 includes a scanner 110, a mail supplying device 100, and a mail conveying device 120. The mail supplying device 110 automatically supplies a large amount of mail to the scanner. The present invention is not limited to the mail supplying device and the mail may be allowed to individually pass through the scanner. The scanner 110 scans the mail supplied from the mail supplying device to acquire mail information. As described above, the mail information may be address information of the mail or barcode information of the registered mail. The mail that passes through the scanner 110 is conveyed to the sorting box through the mail conveying device 120.

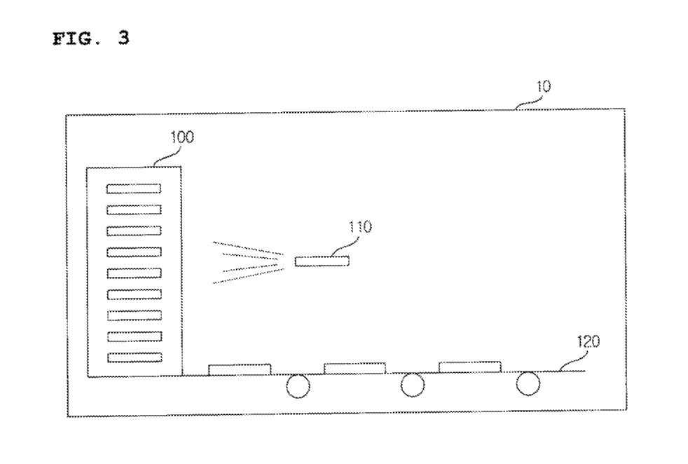

FIG. 3 is a block diagram of the sorting unit 20 according to the exemplary embodiment of the present invention.

The sorting unit 20 of FIG. 3 includes a mail information DB and a processing server 220.

The mail information DB may include a census statistics DB 210, a postal area DB 220, a registered mail statistics DB 240, and a sorting box DB 250.

Address information of a building, an administrative district, or a road in the postal area for each mailman is stored in the postal area DB 220 in advance and the processing server 220 of the sorting unit 20 determines information to be displayed in each sorting box in accordance with the postal area information. In the determination method, the information to be displayed in each sorting box may be determined by one sorting box per one town and the information to be displayed in each sorting box may be determined by one sorting box per two towns. Alternatively, the information to be displayed in each sorting box may be determined by one sorting box per one building. The present invention is not limited to the aforementioned determination method. When the postal area information is updated, the information to be displayed in each sorting box is also updated.

The registered mail statistics DB 240 stores mail amount statistics of the registered mail in advance, and the processing server 220 of the sorting unit 20 determines the information to be displayed in each sorting box in accordance with the mail amount statistics. In this case, the processing server 220 may determine the information to be displayed in each sorting box so that a sorting box corresponding to an area having more mail amount is assigned to a position closer to a mail sorting operator. A method of determining the information to be displayed in each sorting box so as to evenly input the mail in each sorting box in accordance with the mail amount may be used. The present invention is not limited to the aforementioned methods.

When the registered mail statistics DB is updated, the information to be displayed in each sorting box is determined based on the updated registered mail statistics DB.

The census statistics DB 210 stores population density in advance, and the processing server 220 of the sorting unit 20 determines the information to be displayed in each sorting box in accordance with the population density. In this case, the processing server 220 may determine the information to be displayed in each sorting box so that a sorting box corresponding to an area having higher population density is assigned to a position closer to the mail sorting operator. A method of determining the information to be displayed in each sorting box so as to evenly distribute population density may be used. The present invention is not limited to the aforementioned methods.

The information displayed in each sorting box based on the mail information DB is address information of each sorting box. The processing server 220 of the sorting unit 20 updates the sorting box DB 250 storing, in advance, address information the existing sorting box by using the address information of each sorting box.

The processing server 220 of the sorting unit 20 determines the information to be displayed in each sorting box by matching the determined address information of each sorting box and the address information acquired by the information acquiring unit, and the information is an input display indicating a sorting box into which the mail is input.

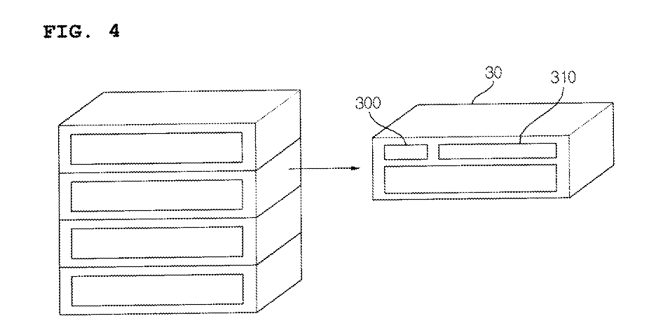

FIG. 4 is a schematic diagram of the display unit 30 according to the exemplary embodiment of the present invention.

The display unit 30 of FIG. 4 includes a mail input display 300 and a sorting box address display 310.

The display unit 30 receives the information to be displayed in each sorting box and displays the received information. The information to be displayed in each sorting box is address information of each sorting box and a mail input display. The address information of each sorting box is displayed in the sorting box address display 310 and the sorting box to be input with the corresponding mail is displayed or lighted in the mail input display 300.

The exemplary embodiment of the present invention is described below. If the sorting box address display 310 needs to be differentiated due to a change of the postal area of the mailman, an increase/decrease of the population density, changes of the building, the administrative district, the road, the address, or the like, in the existing case, inconvenience in which the mailman needs to manually display the changes may be caused and differentiating the sorting box address display 310 may be an additional business element. However, according to the exemplary embodiment of the present invention, the change of the postal area or the changes of the building, the administrative district, or the like is performed through updating the postal area DB, the change by the increase/decrease of the population density is performed through updating the census DB, and when updating the registered mail statistics DB, the information to be displayed in each sorting box in the processing server 200 is automatically updated, thereby attempting the efficiency of the business.

Another exemplary embodiment of the present invention is described below. When the position and address information of the sorting box are changed due to the situation, the mailman needs to adapt to changed sorting box and sorting box information in the existing case. In the registered mail, the mailman has inconvenience to scan barcode information with a PDA one by one. According to the exemplary embodiment of the present invention, since information on the large amount of mail is scanned in the information acquiring unit 10, the trouble may be saved and since the corresponding mail is input into the sorting box which is lighted depending on the lighting of the mail input display 300 of the sorting box, the problem may be solved.

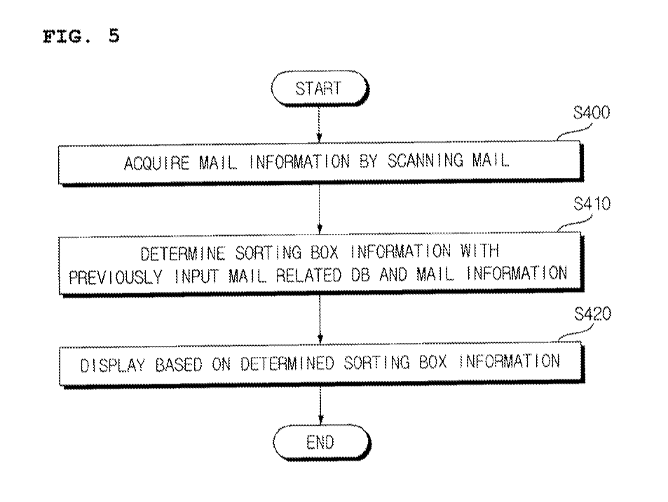

FIG. 5 is a flowchart of a method of automatically setting sorting boxes for automatic mail sorting according to an exemplary embodiment of the present invention.

An information acquiring unit 30 of a system of automatically setting sorting boxes for automatic mail sorting acquires information of mail by scanning the mail (S400).

The information of the mail may be character recognition information of the mail or barcode information of registered mail. The character recognition information is finally acquired as address information, and the barcode information is finally acquired based on a registered mail DB as the barcode information. As a scanning method, barcode recognition using a barcode sensor, character recognition through image photographing and reading, or information recognition using an RFID tag may be used. However, the present invention is not limited to the aforementioned methods. The acquired mail information is transmitted to a sorting unit 20.

The information acquiring unit 10 may include a scanner acquiring information of the mail, a mail supplying device automatically supplying a large amount of mail to the scanner, and a mail conveying device automatically conveying the scanned mail.

The sorting unit 20 determines a mail information DB which is stored in advance and information to be displayed in each sorting box input with the mail based on the received mail information (S410).

The mail information DB may include a census DB, a postal area DB, and a registered mail statistics DB. The information to be displayed in each sorting box is address information of each sorting box or an input display of the sorting box to be input with the mail.

The sorting unit 20 may further include a function to update a sorting box DB that stores, in advance, address information of the existing sorting box by using the address information of each sorting box.

The display unit 30 displays information in each sorting box based on the information to be displayed in each sorting box (S420).

The displayed information may be an address and a mail input display displayed in the sorting box.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system of automatically setting sorting boxes for automatic mail sorting, the system comprising:
a sorting unit determining information to be displayed in each sorting box input with mail based on a mail information DB constructed in advance; and
a display unit receiving the information to be displayed in each sorting box and displaying the received information.

2. The system of claim 1, wherein
the mail information DB of the sorting unit includes a postal area DB storing, in advance, address information in a postal area for each mailman, and
the sorting unit determines the information to be displayed in each sorting box in accordance with the postal area information.

3. The system of claim 2, wherein
the mail information DB of the sorting unit further includes a registered mail statistics DB storing an amount statistics of an existing registered mail, and
the sorting unit determines the information to be displayed in each sorting box by further considering the amount statistics.

4. The system of claim 2, wherein
the mail information DB of the sorting unit further includes a census statistics DB storing, in advance, population density statistics, and
the sorting unit determines the information to be displayed in each sorting box by further considering the population density statistics.

5. The system of claim 2, wherein
the information to be displayed in each sorting box of the sorting unit is address information of each sorting box, and
the sorting unit updates a sorting box DB storing, in advance, the address information of the existing sorting box by using the address information of each sorting box.

6. The system of claim 3, wherein
the information to be displayed in each sorting box of the sorting unit is address information of each sorting box, and
the sorting unit updates a sorting box DB storing, in advance, the address information of the existing sorting box by using the address information of each sorting box.

7. The system of claim 4, wherein
the information to be displayed in each sorting box of the sorting unit is address information of each sorting box, and
the sorting unit updates a sorting box DB storing, in advance, the address information of the existing sorting box by using the address information of each sorting box.

8. The system of claim 1, further comprising:
an information acquiring unit scanning mail input from the outside to acquire mail information,
wherein the mail information of the information acquiring unit is character recognition information of the mail or barcode information of the registered mail, and
the information acquiring unit acquires address information from the character recognition information or the barcode information.

9. The system of claim 8, wherein
the mail information DB of the sorting unit includes a sorting box DB storing, in advance, the address information of each sorting box, and
the sorting unit further determines the information to be displayed in each sorting box by matching the address information of each sorting box and the address information acquired by the information acquiring unit.

10. The system of claim 9, wherein
the information to be displayed in each sorting box includes the address information of each sorting box and an input display indicating a sorting box into which the mail is input.

11. The system of claim 10, wherein
the information acquiring unit includes
a scanner acquiring information of mail;
a mail supplying device automatically supplying a large amount of mail to the scanner; and
a mail conveying device conveying the mail the information of which has been already acquired by the scanner.

12. A method for automatically setting sorting boxes for automatic mail sorting, the method comprising:
determining information to be displayed in each sorting box input with mail based on a mail information DB constructed in advance; and
receiving the information to be displayed in each sorting box and displaying the received information.

13. The method of claim 12, wherein
the mail information DB includes a postal area DB storing, in advance, address information in a postal area for each mailman, and
the step of determining information to be displayed in each sorting box input with mail further comprises determining information to be displayed in each sorting box in accordance with the address information in the postal area.

14. The system of claim 13, wherein
the mail information DB of the determining includes a registered mail statistics DB storing, in advance, mail amount statistics of existing registered mail, and
in the determination method of the determining, the information to be displayed in each sorting box is determined in accordance with the mail amount statistics.

15. The method of claim 13, wherein
the mail information DB of the determining includes a census statistics DB storing, in advance, population density statistics, and
in the determination method of the determining, the information to be displayed in each sorting box is determined in accordance with the population density.

16. The method of claim 13, wherein
the information to be displayed in each sorting box of the determining is address information of each sorting box, and
the determining further includes updating a sorting box DB storing, in advance, the address information of the existing sorting box by using the address information of each sorting box.

17. The method of claim 14, wherein
the information to be displayed in each sorting box of the determining is address information of each sorting box, and
the determining further includes updating a sorting box DB storing, in advance, the address information of the existing sorting box by using the address information of each sorting box.

18. The method of claim 15, wherein
the information to be displayed in each sorting box of the determining is address information of each sorting box, and
the determining further includes updating a sorting box DB storing, in advance, the address information of the existing sorting box by using the address information of each sorting box.

19. The method of claim 12, further comprising:
scanning the mail to acquire mail information, before the determining,
wherein the mail information of the acquiring is character recognition information of the mail or barcode information of the registered mail, and
the address information is acquired from the character recognition information or the barcode information.

20. The method of claim 19, wherein
the mail information DB of the determining includes a sorting box DB storing, in advance, the address information of each sorting box, and
in the determining, the information to be displayed in each sorting box is determined by matching the address information of each sorting box and the address information acquired by the information acquiring unit.

21. The method of claim 20, wherein the information to be displayed in each sorting box is an input display indicating a sorting box into which the mail is input.
